(19) United States
(12) Patent Application Publication
(10) Pub. No.: US 2025/0280838 A1
(43) Pub. Date: Sep. 11, 2025

(54) METHOD AND APPARATUS FOR ANESTHETIZING SLAUGHTER ANIMALS

(71) Applicants: MAREL MEAT A/S, Roskilde (DK); MAREL ICELAND EHF., Gardabaer (IS)

(72) Inventors: Leif LYKKE, Roskilde (DK); Heinz MADSEN, Roskilde (DK); Karl SIGURJONSSON, Roskilde (DK); Patrick WESTERGAARD, Roskilde (DK)

(21) Appl. No.: 18/861,297

(22) PCT Filed: May 11, 2023
(86) PCT No.: PCT/EP2023/062562

§ 371 Date: Oct. 29, 2024

(30) Foreign Application Priority Data
May 12, 2022 (EP) 22173030.2

(51) Int. Cl. A22B 3/00; A22B 7/00; A61D 7/04

(52) U.S. Cl. CPC A22B 3/005; A22B 7/001; A61D 7/04

(57) ABSTRACT

An anesthetization apparatus for anesthetization of four-legged slaughter animals, prior to slaughter, wherein the anesthetization apparatus includes: a receiving section configured to receive a pre-filled box containing one or more slaughter animals; a anesthetization compartment; a transport mechanism for transporting the received box between the receiving section and the anesthetization compartment; and a removal mechanism for removing the box from the anesthetization compartment, wherein the anesthetization apparatus further comprises a stress-reducing compartment configured for receiving the box from the receiving section, accommodating the box for a period of time for calming the slaughter animals in the received box before anesthetizing; and wherein the transport mechanism is configured to transport the received box between the receiving section and the stress-reducing compartment and from the stress-reducing compartment to the anesthetization compartment.

### TECHNICAL FIELD

The present invention relates to an apparatus and a corresponding method for anesthetizing slaughter animals, in particular four-legged slaughter animals, such as hoofed animals, in particular pigs and cattle.

### BACKGROUND

Awareness of animal well-being is today highly respected e.g. in abattoirs. The purpose of anesthetizing animals is to deprive the animals of pain perception, such as prior to slaughter. The anesthetization procedure should ensure that no animals regain consciousness before, during or after the slaughtering process.

When anesthetizing animals by gas, there is a progressive loss of consciousness and anesthesia. The process may be described as a succession of stages, starting from an analgesia stage, followed by an excitation stage, an anesthesia stage and finally collapse.

A frequently used anesthetization method for anesthetizing pigs involves exposure to CO₂. For pigs anesthetized with CO₂ the following can be observed: During the analgesia stage, the pigs are still standing upright; during the excitation stage, pigs are lying down; during the anesthesia stage, pigs still have a corneal reflex, though it disappears in the deep anesthesia; In the collapse stage, the pigs have no reflexes at all.

Despite previous efforts, there is still a need to further reduce the stress level of animals such as pigs associated with the anesthetization process. In particular, it is desirable to further improve animal well-being in connection with the anesthetization procedure. Moreover, the animal reactions may result in bruises and reduce meat quality. On this background and even though the observed reactions during the initial phases of the anesthetization process only last for a short period of time, it is desirable to reduce these reactions to the extent possible.

It is further desirable to provide an anesthetization apparatus and process that is efficient and yields a high throughput.

WO 2021/165279 discloses a method of reducing animal reactions when exposed to a pre-anesthetizing relaxation gas and/or anesthetizing gas during a pre-anesthetizing and/or anesthetization process, the method comprising: exposing at least one animal to a relaxation gas and/or anesthetizing gas for an exposure period; exposing the at least one animal to at least one smell additive at least during a part of said exposure period, in particular during an initial part of said exposure period. The process may involve exposure of the animals to a relaxation gas in a pre-anesthetizing chamber, followed by movement of the animals into an anesthetizing chamber where they are exposed to an anesthetizing gas. While this method considerably reduces animal reactions, it remains desirable to provide a more efficient method without exposing the slaughter animals to unnecessary stress and without compromising meat quality.

EP 2617288 discloses a method that involves conveying and pre-anesthetizing a slaughter animal through a gas environment. The slaughter animal is driven into retainers such that the slaughter animal is upwardly and then downwardly conveyed through a column-like structure that holds the gas environment and into another gas environment by an endless chain, where the gas is used as low density air and helium gas and another gas is used as high density air and carbon dioxide gas. The slaughter animal is anesthetized by the gases in an irreversible manner during conveyance. However, this method requires an apparatus having a large total height.

EP0441633 discloses a method for the anesthetizing of animals to be slaughtered at slaughterhouses. According to this prior art method, anesthetizing of animals to be slaughtered at slaughterhouses takes place by exposing the animals for a sufficiently long period of time to an anesthetic atmosphere, such as an atmosphere of carbon dioxide. To this end, a number of animals is first driven into a transport box which has been placed in a filling area at the slaughterhouse. Then a filled box is transported to a waiting area for boxes, and from this waiting area a box is taken when needed and led through an anesthetizing area filled with the anesthetic atmosphere, such as an oblong pit with room for 2-15 boxes, which are led in one after another. The boxes with anesthetized animals are emptied of animals to be slaughtered, which are chained, whereas the empty boxes are returned to the filling area for renewed use.

However, it remains desirable to provide a method that reduces the stress level of animals such as pigs, cattle or the like associated with the anesthetization process.

### SUMMARY

In general, at least some embodiments of the method and apparatus disclosed herein seek to mitigate, alleviate or eliminate one or more of the above-mentioned disadvantages and/or other disadvantages of the prior art, or to at least serve as an alternative to prior art solutions.

According to one aspect, disclosed herein are embodiments of an anesthetization apparatus for anesthetizing slaughter animals prior to slaughter, wherein the anesthetization apparatus comprises:
a receiving section configured to receive one or more pre-filled boxes, each pre-filled box containing one or more slaughter animals;
an anesthetization compartment;
a transport mechanism for transporting the received one or more boxes between the receiving section and the anesthetization compartment; and
a removal mechanism for removing the one or more boxes from the anesthetization compartment,
   wherein the anesthetization apparatus further comprises a stress-reducing compartment configured for receiving the one or more boxes from the receiving section and for accommodating the one or more boxes for a period of time for calming the slaughter animals in the one or more boxes before anesthetizing; and wherein the transport mechanism is configured to transport the one or more boxes between the receiving section and the stress-reducing compartment and from the stress-reducing compartment to the anesthetization compartment.

Embodiments of the apparatus described herein reduce or even prevent severe reactions that one may otherwise observe before or during the initial phases of the anesthetization process of animals such as pigs. The provision of a stress-reducing compartment where the pre-filled boxes containing the slaughter animals are moved into and held for a period of time sufficiently long for the slaughter animals to calm down has been found to considerably reduce animal reactions during the anesthetization procedure, thereby increasing animal well-being and reducing the risk of downgraded meat quality. The provision of a stress-reducing compartment allows the environment to be carefully controlled during the stress-reducing process and the animals are not distracted by activities outside the stress-reducing compartment. As the animals are received by the apparatus in pre-filled boxes, the stress-reducing process and subsequent anesthetization process can be performed efficiently, as the loading time required for receiving a new group of animals is minimized. Also, as the animals are already in the pre-filled boxes when the boxes are received at the apparatus, the animals have already gotten used to being in the box and may even have had an opportunity to rest after having entered the boxes. The animals are not agitated by being pushed or otherwise urged to walk into the boxes shortly before the anesthetization process.

While the various embodiments of the present apparatus may be used for a variety of slaughter animals, in particular four-legged slaughter animals, such as hoofed animals, they are particularly well suited for anesthetizing porcines, bovidae, bovines and/or caprines prior to slaughter.

In some embodiments, the compartments of the anesthetization apparatus are arranged at two or more levels in height relative to each other, e.g. partly or completely above each other or otherwise at different levels, thus providing a smaller footprint and facilitating the prevention of the anesthetizing gas spreading from the anesthetization compartment into the other compartments of the apparatus. In particular, in some embodiments, at least a part of the stress-reducing compartment is located at an elevated level, higher than the anesthetization compartment. In particular, a bottom of the stress-reducing compartment may be elevated at a level higher than a bottom of the anesthetization apartment, in particular such that, when a box is positioned in an anesthetization position inside the anesthetization compartment, the bottom of the stress-reducing compartment is at the same level as, or at a level higher than, a top of the boxes. The stress-reducing compartment may be elevated at least a level higher than an average height of a back of the slaughter animals, for which the apparatus is configured, when the non-anesthetized slaughter animals are accommodated in the boxes in an anesthetization position inside the anesthetization compartment. When the anesthetizing gas, which may include high concentrations of e.g. CO₂, has a high specific weight and, in particular, a higher specific weight than the relaxation gas in the stress-reducing compartment, arranging the anesthetization compartment at a level lower than, such as below, the stress-reducing compartment reduces the risk of the anesthetizing gas spreading into the stress-reducing compartment.

In some embodiments, the receiving section is arranged at a first level and wherein the transport mechanism comprises:
a first elevating mechanism for elevating the one or more boxes from the first level to a second level higher than the first level; and
a second elevating mechanism for lowering one or more boxes from the second level into the anesthetization compartment, wherein the anesthetization compartment is optionally arranged at the first level. Accordingly, the anesthetization compartment may be arranged at or above the same level at which the animals are received which is typically a floor level of the slaughter facility, thus avoiding having the anesthetization compartment arranged below the floor level. This facilitates maintenance/cleaning access to the anesthetization compartment and the monitoring of the anesthetizing process. The first and second elevating mechanism may be separate from each other or combined into a single mechanism, such as a single conveyor system. In some embodiments, the stress-reducing compartment is arranged above the receiving section.

The receiving section may be formed as a compartment of the apparatus or as an open structure, e.g. next to, below or otherwise proximal to the stress-reducing compartment. The receiving section may comprise a receiving mechanism configured to operationally couple the pre-filled boxes to the transport mechanism when the one or more boxes are received at the receiving section. For example, the receiving mechanism may place the one or more pre-filled boxes on a conveyor, on tracks, on an elevating mechanism, and/or the like.

Examples of a suitable elevating mechanism include a scissor lift, a ramp or other form of lift or crane. The elevating mechanism may be operable to elevate and/or lower the boxes along a vertical trajectory or along an inclined trajectory or otherwise, e.g. along a combination of vertical and inclined paths, a curved path, etc.

The transport and/or elevating mechanism and/or the removal mechanism may be provided as separate mechanisms such that the boxes are transferred from one mechanism to another. Alternatively, the transport and/or elevating mechanism and/or the removal mechanism may partly or completely be integrated into a single transport mechanism, e.g. a continuous conveyor system. Generally, the transport mechanism may include one or more of the following transport mechanisms: a conveyor, tracks, rails, overhead rails, an elevating mechanism, etc. or a combination thereof.

In some embodiments, the anesthetization apparatus comprises a transitional compartment shaped and sized to accommodate the one or more boxes, and wherein the transport mechanism is configured to transport the one or more boxes from the stress-reducing compartment to the transitional compartment and from the transitional compartment to the anesthetization compartment. Accordingly, the anesthetization compartment may be separated from the stress-reducing compartment by the transitional compartment, thereby reducing the risk of undesired mixing of different atmospheres in the anesthetization compartment and the stress-reducing compartment, respectively, in particular the risk of the anesthetizing gas spreading from the anesthetization compartment into the stress-reducing compartment. In some embodiments, the atmosphere in the transitional compartment may be substantially the same as the atmosphere in the stress-reducing compartment, thus avoiding the slaughter animals getting re-agitated during the transition from the stress-reducing compartment into the anesthetization compartment. However, it will be appreciated that, in some embodiments, the atmosphere in the transitional compartment may be different from the atmosphere in the stress-reducing compartment, e.g. have a higher or lower oxygen concentration or otherwise include a different gas mixture.

In some embodiments, the transitional compartment is arranged at an elevated level higher than the anesthetization compartment, in particular partly or completely above the anesthetization compartment. In some embodiments, the transitional compartment is arranged partly or completely on the same level as the stress-reducing compartment. Accordingly, the transport mechanism may comprise a horizontal transport mechanism configured to move the one or more boxes horizontally between the stress-reducing compartment and the transitional compartment. The transport mechanism may further comprise an elevating mechanism configured to lower the one or more boxes from the transitional compartment into the anesthetization compartment.

In some embodiments, the removal mechanism is configured to transport the one or more boxes from the anesthetization compartment to an exit port of the apparatus. In particular, in some embodiments the removal mechanism is configured to transport the one or more boxes from the anesthetization compartment to the exit port via the transitional compartment, thus providing a particularly compact layout of the anesthetization apparatus. However, in other embodiments, the anesthetization compartment may have an entrance at which the boxes enter the anesthetization compartment, in particular from the transitional compartment, and an exit, separate from the entrance, at which the boxes exit the anesthetization compartment, e.g. into an exit compartment, which includes an exit port, or otherwise. Accordingly, a one-way flow of boxes may be provided which facilitates a larger throughput, as a subsequent box may conveniently enter the anesthetization compartment while another box is still inside the anesthetization compartment. For example, the anesthetization compartment may have an elongated shape with the entrance located proximal an entry end of the anesthetization compartment and the exit being located proximal an exit end, opposite the entry end.

In some embodiments, the anesthetization apparatus comprises a passageway between the stress-reducing compartment and the transitional compartment, the passageway being sized and shaped to allow passage of the one or more boxes from the stress-reducing compartment to the transitional compartment, and wherein the anesthetization apparatus further comprises a compartment divider configured to selectively block the passageway between the stress-reducing compartment and the transitional compartment. In some embodiments, the passageway is shaped and sized so as to allow passage of a single box at a time, e.g. such that the boxes may pass through the passageway as sequence of individual boxes. The compartment divider may be configured to selectively open upon only when a box is to pass the passageway. The compartment divider may further be configured to block the passageway after each passage of a single box. In other embodiments, the compartment divider may allow a sequence of several boxes to pass before closing again, e.g. when the boxes pass the passageway in short succession of each other or when the passageway is shaped and sized so as to allow concurrent passage of multiple boxes, e.g. side by side. The passageway may e.g. be formed as an opening in a wall separating the stress-reducing compartment from the transitional compartment. The compartment divider may e.g. be a door, a gate, a curtain, an airlock, a gas curtain, a sectional door, a fabric door, a roller shutter or other form of divider that prevents or at least reduces gas flow between the compartments. In some embodiments, the compartment divider has an open state and a closed state and is configured to prevent or at least reduces gas flow between the compartments at least when the compartment divider is in a closed state. The compartment divider may be movable into an open state so as to allow a box to pass through the passageway. The compartment divider may be opened and closed using a suitably powered mechanism, e.g. electrically or pneumatically powered mechanism. It will be appreciated that compartment dividers may also be provided between the transitional compartment and the removal mechanism and/or between receiving section and the stress-reducing compartment and/or between transitional compartment and anesthetization compartment. Preferably, each compartment divider separating two compartments is configured to close the opening or other passageway between said compartments tight enough to prevent, minimize or at least substantially reduce gas exchange between the compartments. A compartment divider may also be provided at an entrance or exit opening of the apparatus so as to separate a compartment of the apparatus and the surrounding of the apparatus.

In some embodiments, the anesthetization apparatus comprises means for dispensing an anesthetizing gas into the anesthetization compartment so as to create an anesthetizing gas mixture in the anesthetizing compartment. The anesthetizing gas may be, or at least include, CO2. The dispensing system may include a circulation system configured to maintain a substantially uniform atmosphere across the anesthetization compartment, in particular a substantially uniform concentration of the anesthetizing gas. In particular, the anesthetizing gas or gas mixture may include CO₂ at a concentration of at least 30%, such as at least 40%, such as at least 50%, such as at least 70%, such as at least 80%, such as between 80% and 90%. Generally, unless otherwise stated, relative concentrations are intended to refer to relative concentrations by volume. It will be appreciated that the concentration of CO₂ may depend on the type of animal to be anesthetized. The balance may be other gases normally present in atmospheric air. The balance may include a major amount of a physiologically inert gas such as nitrogen or argon. The balance may include a minor amount of oxygen and/or other gases normally present in small amounts in atmospheric air. The oxygen concentration in the anesthetizing gas mixture may be lower than the oxygen concentration in the relaxation gas mixture, e.g. lower by 1-3 percentage-points or more. The O₂ vol % in the anesthetizing gas may be lower than 5%, such as between 2% and 5%. The other gases may have a relative concentration, relative to each other, corresponding to or different from their relative concentrations in atmospheric air. Other examples of anesthetizing gases include mixtures of CO₂ with nitrogen and/or argon. In some embodiments, exposure of the at least one animal to the anesthetizing gas comprises exposure to a physiological effective concentration of the anesthetizing gas, in particular a concentration having anesthetic effect.

Similarly, in some embodiments, the anesthetization apparatus comprises means for providing a stress-reducing gas atmosphere, such as an oxygen-reduced atmosphere in the stress-reducing compartment. The stress-reducing atmosphere is selected such that it does not cause anesthetization, i.e. such that the animals are fully conscious and not pre-anesthetized when leaving the stress-reducing compartment. In some embodiments, the anesthetization apparatus comprises means for exposing the slaughter animals to a relaxation gas in the stress-reducing compartment, e.g. to a relaxation gas mixture comprising O₂ at a concentration below 10%. The O₂ concentration is preferably above a minimum level of oxygen concentration, preferably higher than the anesthetic-causing concentration for the animals being processed. The minimum level of the oxygen concentration in the relaxation gas mixture may differ according to animal species, and may be between 3-10%. Preferably, the oxygen concentration is below 10% and above 4%, such as above 5%, such as above 6%. Especially for pigs the minimum level of the oxygen concentration of the relaxation gas mixture should preferably be about 6% to secure the animals is in a reduced stress level and not anesthetized. The relaxation gas or gas mixture may include one or more other gases normally present in atmospheric air, such as nitrogen, argon, carbon dioxide and combinations thereof. The relaxation gas mixture may further include small amounts of other gases, e.g. gases normally present in atmospheric air in small amounts. Preferably, the relaxation gas or gas mixture comprises a major amount of one or more physiologically inert gases such as nitrogen and/or argon and/or xenon. The term physiologically inert gas is intended to refer to any gas being physiological inert for the animals to be treated. In this respect, generally, CO₂ is not a physiologically inert gas. In some embodiments, the anesthetization apparatus comprises a dispensing system for dispensing the relaxation gas, or at least a component of a relaxation gas mixture, into the stress-reducing compartment. In particular, in some embodiments, the dispensing system is configured to dispense a physiologically inert gas, such as argon and/or xenon and/or nitrogen, into the stress-reducing compartment, e.g. via nozzles or other suitable gas outlet openings. The dispensed relaxation gas or the dispensed component of an anesthetizing gas mixture, e.g. the dispensed physiologically inert gas, is thus different from the anesthetizing gas dispensed into the anesthetization compartment. Use of a relaxation gas, different from the anesthetizing gas, in the stress-reducing compartment, e.g. as opposed to low concentrations of CO₂, helps to avoid undesired reactions of the slaughter animals and, hence, to obtain a high meat quality, in particular in the context of anesthetizing pigs, as pigs have been found to react to low concentrations of CO₂.

In some embodiments, the anesthetization compartment has a bottom and one or more side walls and comprises an access door in said one or more side walls. The bottom is preferably defined by a floor portion of the anesthetization compartment. The side walls typically extend from the bottom upwards. The side walls may have an upper edge defining a top of the anesthetization compartment. The top may be open or closed by a ceiling portion. Accordingly, convenient access to the anesthetization compartment for cleaning and/or maintenance purposes can be provided. The access door may be a scalable door to prevent anesthetizing gas to leak from the anesthetization compartment when the access door is closed. In some embodiments, the anesthetization compartment has a window portion, e.g. a transparent wall portion, in said one or more side walls, thus facilitating visual inspection of the anesthetization process from outside the anesthetization compartment and without personnel having to enter the stress-reducing compartment or the transitional compartment. The access door may be separate from the entrance and exit opening(s) through which the boxes enter/exit the anesthetization compartment. In particular, in some embodiments, the anesthetization compartment defines one or more upwardly open entrance and/or exit openings for allowing the boxes to enter and/or exit the anesthetization compartment from above, while the access door is provided in one of the side walls to allow for a lateral service access.

Similarly, the stress-reducing compartment may include and access door for allowing personnel to access the stress-reducing compartment for cleaning and/or maintenance. The stress-reducing compartment preferably has a window portion configured to allow visual inspection of the slaughter animals accommodated in the stress-reducing compartment. The access door may be separate from the entry and exit opening(s) through which the boxes enter/exit the stress-reducing compartment.

In some embodiments, the stress-reducing compartment comprises one or more of:
means for providing a stress-reducing gas atmosphere, in particular an oxygen-reduced atmosphere, in the stress-reducing compartment,
a sound-insulated enclosure for accommodating the one or more boxes,
a sound system for playing stress-reducing audio content,
an illumination system for providing stress-reducing illumination.

It has been found that calming sounds, such as music, and/or colored illumination may have a stress-reducing effect on the slaughter animals. In particular, green light has been found to have a stress-reducing effect on slaughter animals such as pigs. The green light may by light where the majority of the emitted light intensity has a wavelength in the range between 450 nm and 575 nm, such as between 475 nm and 560 nm, such as between 520 nm and 560 nm. The illumination system is preferably configured so as to allow selective control of the illumination intensity, in particular between a calming intensity of e.g. between 10 lux and 100 lux and an inspection intensity, higher than the calming intensity, e.g. of 100 lux or higher.

The sound system and/or the sound-insulated enclosure are preferably configured to limit the sound level in the stress-reducing compartment to sound levels sufficiently low so as not to agitate the animals and to avoid the need for hearing protection for operators, e.g. to sound levels below 80 dB, such as below 60 dB, such as below 50 dB, such as 40 dB or lower. The sound system is preferably configured to play sounds, such as music. Preferably, the sounds, such as the music, has a limited dynamic variation, e.g. below 2 dB such as below 1 dB, so as to avoid agitating the animals. One suitable example of music having a low dynamic variation includes pan-flute music.

In some embodiments, the transitional compartment and/or the anesthetization compartment is/are configured to provide the same, similar or different stress-reducing measures as the stress-reducing compartment, e.g. provision of a smell-additive and/or stress-reducing illumination and/or sound.

Preferably, the temperature inside the stress-reducing compartment is kept at or near a thermo-neutral range for the slaughter animals to be processed by the apparatus, such as between 13° C. and 25° C., e.g. between 15° C. and 20° C., such as between 16° C. and 18° C. Preferably, the temperature inside the anesthetization apparatus is kept substantially similar or even equal in the different compartments of the apparatus where the animals are accommodated and/or processed. Accordingly, in some embodiments, the anesthetization apparatus comprises a temperature regulating system, such as a heating and/or cooling system, for regulating the temperature in the stress-reducing compartment and/or the transitional compartment and/or the anesthetization compartment.

In some embodiments, the apparatus comprises a dispensing system for dispensing a smell additive in the anesthetization compartment and/or in the stress-reducing compartment, where the smell additive is selected so as to mask the perception of the anesthetizing gas by the slaughter animals, e.g. as described in WO 2021/165279, the entire contents of which are included herein by reference. The smell additive may be a gaseous smell additive or a liquid smell additive, e.g. dispersed as a mist. The smell additive may be pre-mixed into the anesthetizing gas and/or the relaxation gas, or be dispensed separately therefrom, e.g. via separate nozzles. The apparatus may comprise a tank or other form of reservoir for holding a supply of smell-additive. When the smell-additive is provided as a mixture or solution, the apparatus may comprise a suitable mixer, e.g. configured to mix the smell additive in the reservoir.

In some embodiments, the stress-reducing compartment and/or the anesthetization compartment is shaped and sized to accommodate a single box, thus providing a particularly compact layout. In other embodiments, the stress-reducing compartment and/or the anesthetization compartment is shaped and sized to accommodate more than one box at the same time, such as five boxes or more, such as 10 boxes or more. For example, the stress-reducing compartment and/or the anesthetization compartment may be tunnel-shaped or otherwise have an elongated shape having an entry end and an exit end, opposite the entry end. Accordingly, a sequence of boxes may slowly be moved through the stress-reducing compartment and/or the anesthetization compartment, in particular as a single file of boxes, thereby providing a high throughput. In some embodiments, the stress-reducing compartment has an elongated shape having an entry end and an exit end. The elongated stress-reducing compartment may have a length defined between the entry end and the exit end, which is larger than a length of the individual boxes, e.g. defined along the direction of travel of the boxes, e.g. at least twice the length of the individual boxes, such as at least three times the length of the individual boxes, or even longer. Accordingly, the boxes may slowly be conveyed through the stress-reducing compartment so as to reduce or even eliminate the need for stopping and re-accelerating the boxes. Alternatively or additionally, more than one box may be accommodated in the stress-reducing compartment concurrently. The elongated stress-reducing compartment may be arranged predominantly or even completely horizontal, e.g. such that the movement path of the boxes through the stress-reducing compartment has an inclination of less than 30%, such as less than 20%, such as less than 10%. Accordingly, the overall height of the apparatus may be kept relatively small. This is particularly advantageous, when the entire apparatus is arranged at or above a floor level of a slaughter facility.

The present disclosure relates to different aspects including the apparatus described above and in the following, corresponding systems, methods, and/or products, each yielding one or more of the benefits and advantages described in connection with one or more of the other aspects, and each having one or more embodiments corresponding to the embodiments described in connection with one or more of the other aspects and/or disclosed in the appended claims.

In particular, according to one aspect, disclosed herein are embodiments of a method for anesthetization of slaughter animals prior to slaughter. Various embodiments of the method comprise:

receiving at least one pre-filled box containing one or more slaughter animals; transporting the received box to a stress-reducing compartment;

accommodating the box inside the stress-reducing compartment for a period of time; transporting the box between the stress-reducing compartment to an anesthetization compartment;

anesthetizing the animals, in particular by exposing the animals to an anesthetizing gas;

removing the box with the anesthetized animals from the anesthetization compartment.

The boxes may be accommodated in the stress-reducing compartment for at least a predetermined relaxation time, in particular long enough to ensure that the slaughter animals are calm. In some embodiments, each box is held in the stress-reducing compartment for at least 3 minutes, such as at least 5 minutes, such as between 3 and 15 minutes, such as between 5 and 10 minutes, or longer. The boxes may be held stationary during the relaxation time or they may move during the relaxation time, e.g. traversing the stress-reducing compartment from an entrance to an exit at a speed selected such that the boxes remain in the stress-reducing compartment for at least the predetermined relaxation time.

The boxes may be accommodated in the anesthetization compartment for an anesthetization time long enough to ensure anesthetization of all animals in each box, such as between 2 minutes and 10 minutes, such as between 2 minutes and 7 minutes, such as between 2 minutes and 6 minutes.

According to yet another aspect, embodiments of a slaughter facility include an anesthetization apparatus disclosed above and in the following and, optionally, a lairage section for accommodating one or more boxes, each box containing one or more slaughter animals, and a transport mechanism for transporting a box from the lairage section to the receiving section of the anesthetization apparatus.

Generally, in various embodiments disclosed herein, the boxes are pre-filled when received by the anesthetization apparatus, i.e. the slaughter animals are already inside the boxes when the boxes arrive at and are received by the receiving section of the anesthetization apparatus. In particular, the slaughter facility may comprise a loading station for loading the boxes with slaughter animals, where the loading stations is separate and spaced apart from the receiving section of the anesthetization apparatus, i.e. the boxes are loaded with animals outside the anesthetization apparatus, such as while the boxes are decoupled from the transport mechanism of the anesthetization apparatus. Accordingly, after loading the boxes with slaughter animals, pre-filled boxes may individually and selectively be diverted to alternative locations, different from the anesthetization apparatus, e.g. for further examination or unloading of selected animals from the box. The slaughter facility may comprise a transport mechanism, e.g. a conveyor system, for transporting the pre-filled boxes between the loading station and the receiving section of the anesthetization apparatus, where the pre-filled boxes may be operationally coupled to the transport mechanism of the anesthetization apparatus. The slaughter facility may comprise a lairage area where the pre-filled boxes may be held prior to being transported to the anesthetization apparatus, in particular so as to allow the slaughter animals to rest in the boxes, e.g. for at least 15 minutes, such as at least 30 minutes, such as for at least 45 minutes. As the transport of the animals between the loading station, lairage, and anesthetization apparatus occur in boxes, the processing and transporting of the slaughter animals may be automated to a high degree and is less labor intensive.

The slaughter facility may comprise a cleaning station for cleaning empty boxes after the animals have been removed from the boxes and before the boxes again are loaded with new slaughter animals.

Generally, the boxes may be shaped and sized to accommodate one or more slaughter animals at a time, such as between 2 and 15 animals, such as between 3 and 8 animals. The boxes may be formed as cages or otherwise ventilated structures having openings in one or more walls. For example, one or more walls of the boxes may be formed by bars separated by openings. The boxes may comprise one or more entrances, e.g. doors or gates, through which the slaughter animals can enter the box and that can be closed when the animals have entered the box, i.e. the pre-filled boxes have closed entrances such that the animals are prevented from leaving the pre-filled box.

According to yet another aspect, disclosed herein are embodiments of an anesthetization apparatus for anesthetizing slaughter animals prior to slaughter, wherein the anesthetization apparatus comprises:
a receiving section configured to receive one or more slaughter animals in one or more boxes;
an anesthetization compartment;
a transport mechanism for transporting the one or more boxes between the receiving section and the anesthetization compartment; and
a removal mechanism for removing the one or more boxes from the anesthetization compartment,
   wherein the anesthetization apparatus further comprises:
a stress-reducing compartment configured for receiving the one or more boxes from the receiving section, accommodating the one or more boxes for a period of time for calming the slaughter animals in the one or more boxes before anesthetizing, and a
a transitional compartment shaped and sized to accommodate the one or more boxes,
   wherein the transport mechanism is configured to transport the one or more box between the receiving section and the stress-reducing compartment, from the stress-reducing compartment to the transitional compartment and from the transitional compartment to the anesthetization compartment; wherein the transitional compartment is separated from the stress-reducing compartment by a compartment divider configured to selectively block a passageway between the stress-reducing compartment and the transitional compartment.

Preferably, the apparatus according to this aspect is configured to receive the animals in pre-filled boxes. However, the provision of a transitional compartment as described herein may also be beneficial in embodiments of an anesthetization apparatus where the slaughter animals are received in another way, e.g. walk into the apparatus.

According to yet another aspect, disclosed herein are embodiments of an anesthetization apparatus for anesthetizing slaughter animals prior to slaughter, wherein the anesthetization apparatus comprises:
a receiving section configured to receive one or more slaughter animals in one or more boxes;
an anesthetization compartment;
a transport mechanism for transporting the one or more boxes between the receiving section and the anesthetization compartment; and
a removal mechanism for removing the one or more boxes from the anesthetization compartment,
   wherein the anesthetization compartment has a bottom and one or more side walls and defines one or more upwardly open entrance and/or exit openings configured to allow the boxes to enter and/or exit the anesthetization compartment, and wherein the anesthetization compartment comprises an access door in said one or more side walls and/or a transparent window portion in said one or more side walls.

Preferably, the apparatus according to this aspect is configured to receive the animals in pre-filled boxes. However, the provision of an anesthetization compartment having an access door and/or a transparent window portion in one or more of its side walls for convenient monitoring of the anesthetization process and/or for convenient access for maintenance or cleaning as described herein may is also beneficial in embodiments of an anesthetization apparatus where the slaughter animals are received in another way, e.g. walk into the apparatus.

### BRIEF DESCRIPTION OF THE DRAWINGS

FIG. 1 schematically illustrates an embodiment of an anesthetization apparatus.

FIG. 2 schematically illustrates another embodiment of an anesthetization apparatus.

FIG. 3 schematically illustrates yet another embodiment of an anesthetization apparatus.

FIG. 4 schematically illustrates yet another embodiment of an anesthetization apparatus.

FIG. 5 schematically illustrates yet another embodiment of an anesthetization apparatus.

FIG. 6 schematically illustrates yet another embodiment of an anesthetization apparatus.

FIG. 7 schematically illustrates yet another embodiment of an anesthetization apparatus.

FIG. 8 schematically illustrates yet another embodiment of an anesthetization apparatus.

FIG. 9 schematically illustrates yet another embodiment of an anesthetization apparatus.

FIG. 10 schematically illustrates an embodiment of a slaughter facility.

### DETAILED DESCRIPTION

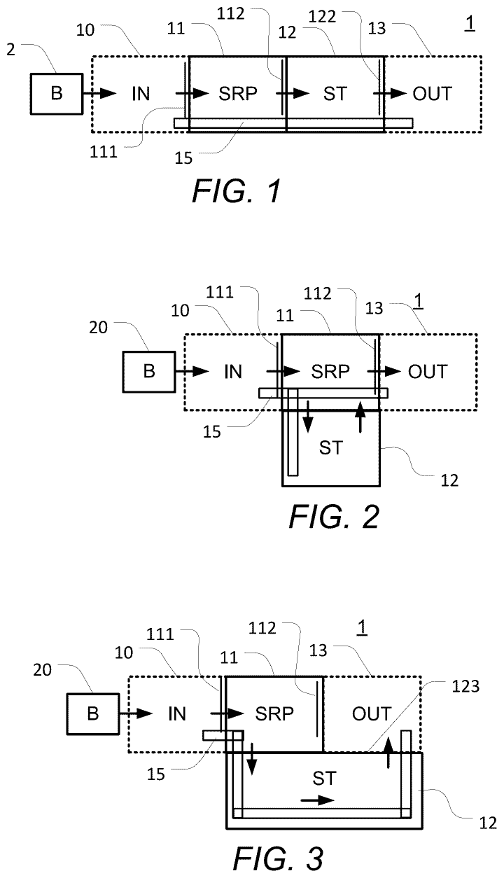

FIGS. 1-9 schematically illustrate embodiments of an anesthetization apparatus, generally designated by reference numeral 1, for anesthetizing slaughter animals prior to slaughter. The described embodiments are particularly suitable for anesthetizing animals such as pigs, cattle or the like prior to slaughter. Generally, the anesthetization apparatus comprises a receiving section 10, a stress-reducing compartment 11 and an anesthetization compartment 12.

The receiving section 10 is configured to receive one or more pre-filled boxes 2, each pre-filled box containing one or more slaughter animals. Accordingly, the boxes are shaped and sized so as to accommodate one or more slaughter animals such as pigs or cattle, where the animals may stand up. The receiving section may be formed as a compartment with an entrance door or as a partly or completely open structure, e.g. a ramp, a conveyor mechanism, a lift or the like. The receiving section of the anesthetization apparatus may receive the pre-filled boxes from another conveyor mechanism, from a forklift, or any other suitable means for transporting the boxes to the receiving section. The receiving section may be configured to receive a single box at a time, a sequence of boxes or multiple boxes simultaneously.

The anesthetization apparatus 1 further comprises a transport mechanism 15 for transporting the received one or more boxes 2 between the receiving section 10 and the anesthetization compartment 12. In particular, the transport mechanism 15 is configured to transport the one or more boxes 2 from the receiving section 10 to the stress-reducing compartment 11, and from the stress-reducing compartment 11 to the anesthetization compartment 12. The transport mechanism 15 may include one or more conveyor mechanisms. In some embodiments, the transport mechanism may include one or more elevating mechanisms, such as a lift or and inclined conveyor. The transport mechanism may include multiple parts, e.g. between which the boxes may be transferred automatically. Preferably, the transport mechanism is configured to provide smooth accelerations, e.g. s-curve acceleration, of the boxes, preferably during horizontal and/or vertical movement. As will be described in greater detail below, the receiving section 10 may comprise a receiving mechanism configured for operationally coupling the received box to the transport mechanism 15, e.g. for placing the received box on a conveyor mechanism or elevating mechanism, for suspending the box from an overhead rail, and/or the like. The receiving mechanism may be formed as a receiving end of a conveyor, an overhead rail, a lifting device for lifting a box on a conveyor, and/or the like.

The stress-reducing compartment 11 is configured for receiving the one or more boxes from the receiving section and for accommodating the one or more boxes for a period of time for calming the slaughter animals in the received box before anesthetizing. To this end, the stress-reducing compartment may define an enclosure in which gas can be dispensed so as to expose the slaughter animals to a relaxation gas or gas mixture inside the stress-reducing compartment, in particular an oxygen-reduced atmosphere. The stress-reducing compartment may comprise a dispensing system for dispensing a relaxation gas or gas mixture, or for dispensing one or more gas components of a relaxation gas mixture. The dispensing system may include a circulation system configured to maintain a substantially uniform atmosphere across the stress-reducing compartment, in particular a substantially uniform concentration of the relaxation gas. As described in more detail above, the relaxation gas may be a gas mixture comprising O₂ at a concentration below 10% and above a minimum level of oxygen concentration, higher than the anesthetic-causing concentration for the slaughter animals. The minimum level of the oxygen concentration in the gas mixture may differ according to animal species, and may be between 3-10%. As described above, the apparatus may comprise further mechanisms for creating a stress-reducing environment inside the stress-reducing compartment. In some embodiments, the stress-reducing compartment comprises a dispensing mechanism for dispensing a stress-reducing smell additive. The stress-reducing compartment may include an illumination system for providing an illumination at an intensity and/or color suitable for calming the animals. Alternatively or additionally, the stress-reducing compartment may include an audio system for playing music and/or other sounds of a type and at a volume suitable for calming the animals.

The stress-reducing compartment has an entrance and an exit. The exit is preferably different from the entrance, so as to allow a one-way movement of the boxes. Preferably, the entrance and the exit are provided as openings that can be selectively closed by a door, gate, curtain or other form of compartment divider so as to facilitate maintaining the relaxation gas atmosphere inside the stress-reducing compartment and so as to prevent undesired amounts of anesthetizing gas to enter the stress-reducing compartment. Depending on the layout of the apparatus, in particular depending on the position of the stress-reducing compartment relative to the receiving section and the subsequent compartment of the apparatus, the entrance and/or exit may be in a side wall of the stress-reducing compartment, in a floor portion or in a ceiling portion.

The anesthetization compartment 12 may be an enclosure having a floor portion and one or more side walls. The anesthetization compartment may have a ceiling portion or it may be upwardly open. The anesthetization compartment may define an enclosure in which gas, in particular an anesthetizing gas or one or more anesthetizing gas components of an anesthetizing gas mixture, can be dispensed so as to expose the slaughter animals to an anesthetizing gas inside the anesthetization compartment, in particular to a gas mixture including CO₂ at concentrations sufficiently high to cause anesthetization. The anesthetizing gas mixture may include CO₂ at a concentration of at least 30%, such as at least 40%, such as at least 50%, such as at least 70%, such as at least 80%. It will be appreciated that the concentration of CO₂ may depend on the type of animal to be anesthetized. In some embodiments, the anesthetization compartment comprises a dispensing mechanism for dispensing a stress-reducing smell additive.

The apparatus further comprises a removal mechanism 13 for removing the one or more boxes from the anesthetization compartment 12. The removal mechanism may be a part of the transport mechanism or it may at least partially be separate from the transport mechanism. The removal mechanism may comprise a mechanism for disengaging the boxes from the transport mechanism such that the boxes can be transported further, e.g. by transferring the boxes to another conveyor system. In some embodiments, the removal mechanism comprises a mechanism for opening the boxes after removal from the anesthetization compartment, so as to allow access to the anesthetized animals, in particular to remove the animals from the box.

It will be appreciated that the stress-reducing compartment 11 and/or the anesthetization compartment 12 may be shaped and sized so as to accommodate single box at a time or more than one boxes at the same time. For example, the stress-reducing compartment and/or the anesthetization compartment may be formed as an elongated, straight or bent, tunnel where boxes enter in one end of the tunnel and exit at the other end of the tunnel.

The anesthetization apparatus may include one or more further compartments and/or the compartments may be arranged relative to each other in various ways.

In particular, in the example schematically shown in FIG. 1, the receiving section 10, the stress-reducing compartment 11, the anesthetization compartment 12 and the removal mechanism 13 are all arranged at substantially the same level, i.e. the boxes are transported through the apparatus along a substantially horizontal path. To this end, the transport mechanism 15 may be a horizontal conveyor by which the boxes are transported along rails or other guides. The entrance to the stress-reducing compartment may thus be formed as an opening in a side or end wall of the stress-reducing compartment, which opening is covered by a compartment divider 111, such as a door, gate, curtain or the like.

Similarly, the passage between the stress-reducing compartment 11 and the anesthetization compartment 12 may be formed as another opening in another side or end wall of the stress-reducing compartment, preferably an opening that can selectively be covered by a compartment divider 112, e.g. a door, gate or curtain.

Yet similarly, the exit of the anesthetization compartment may be formed as another opening in another side or end wall of the anesthetization compartment, preferably an opening that can selectively be covered by a compartment divider 122, e.g. a door, gate or curtain.

In the example of FIG. 1, the anesthetization compartment 12 is directly adjacent to the stress-reducing compartment 11, i.e. the compartment divider 112 forms the exit of the stress-reducing compartment and the entrance to the anesthetization compartment.

FIG. 2 schematically illustrates another embodiment of an anesthetization apparatus 1. In the example of FIG. 2, the anesthetization compartment 12 is located below the stress-reducing compartment 11. For example, the stress-reducing compartment may be located on the floor level of a slaughter facility and the anesthetization compartment may be formed as a pit or hole extending below the floor level. Alternatively, the anesthetization compartment 12 may be located on the floor level of a slaughter facility and the stress-reducing compartment may be located at a level elevated above the floor level. Positioning the anesthetization compartment 12 at a level below the stress-reducing compartment 11 may facilitate preventing anesthetizing gas from spilling from the anesthetization compartment into the stress-reducing compartment, even without a closable door separating the two compartments. This is in particular the case if the anesthetizing gas, or at least the anesthetizing gas component of the anesthetizing gas mixture, has a specific weight higher than the specific weight of the relaxation gas or otherwise of the atmosphere in the stress-reducing compartment and/or higher than the specific weight of air.

Accordingly, the anesthetization apparatus 1 may comprise at least one elevation mechanism, e.g. a lift, such as a scissor lift, configured to lower a box from the stress-reducing compartment into the anesthetization compartment. The same elevation mechanism may serve as part of the removal mechanism 13 and elevate the box back out of the anesthetization compartment. In the example of FIG. 2, the removal mechanism elevates the box back into the stress-reducing compartment 11 and then laterally out of an exit opening in a side wall of the stress-reducing compartment, e.g. by a horizontal conveyor. The exit opening is preferably covered by a compartment divider 112, e.g. a door, gate or curtain. However, in other embodiments, removal of the box from the anesthetization compartment 12 may be made along a different path, e.g. as illustrated in FIG. 3.

FIG. 3 schematically illustrates another embodiment of an anesthetization apparatus 1. The anesthetization apparatus of FIG. 3 is similar to the one of FIG. 2, except that the anesthetization compartment 12 laterally extends beyond the stress-reducing compartment 11 and the removal mechanism 13 is configured to remove the boxes from the apparatus directly from the anesthetization compartment via exit 123 without having to traverse the stress-reducing compartment 11 again, thus allowing for a more efficient flow. In some embodiments, removal of the boxes from the anesthetization compartment may be provided via an exit compartment, separate from the stress-reducing compartment.

Even though the boxes do not return to the stress-reducing compartment after anesthetization of the animals accommodated in the box, the stress-reducing compartment 11 may optionally have an exit opening covered by a suitable compartment divider 112 anyway, so as to allow a box to be removed from the stress-reducing compartment without entering the anesthetization compartment 12.

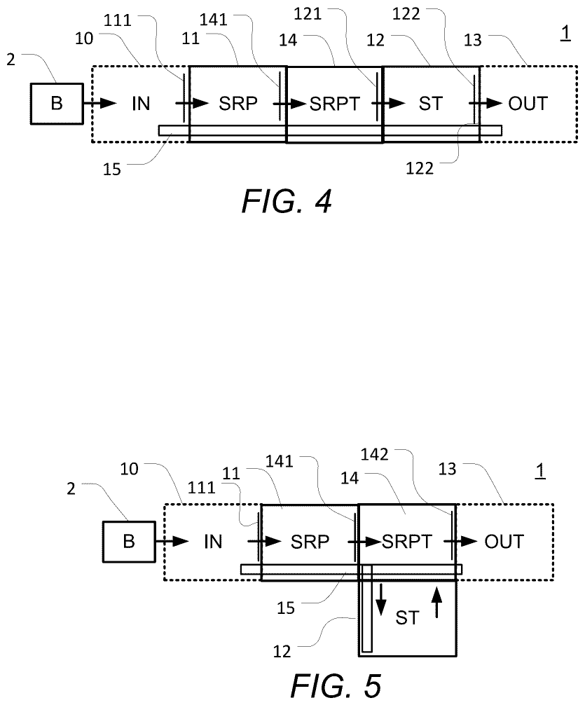

FIGS. 4 through 9 schematically illustrate further embodiments of an anesthetization apparatus.

The embodiments of FIGS. 4 through 7 differ from the embodiments of FIGS. 1-3 in that the embodiments of FIGS. 4 through 7 comprise an additional compartment, namely a transitional compartment 14. The transitional compartment 14 is shaped and sized to accommodate one or more boxes, and the transport mechanism 15 is configured to transport the one or more boxes from the stress-reducing compartment 11 to the transitional compartment 14 and from the transitional compartment to the anesthetization compartment 12.

Accordingly, the boxes are not transferred directly from the stress-reducing compartment 11 into the anesthetization compartment 12 but, instead, via the transitional compartment 14. This reduces the risk of undesired mixing of the anesthetizing gas with the relaxation gas and, in particular prevents undesired amounts of anesthetizing gas from spilling into the stress-reducing compartment 11. Alternatively, moving the boxes directly from the stress-reducing compartment to the anesthetization compartment may reduce the need for stopping and/or accelerating the boxes prior to anesthetization.

In some embodiments, the transitional compartment 14 is configured for receiving the one or more boxes from the stress-reducing compartment 11 and for transferring the received boxes further to the anesthetization compartment 12. Preferably, the transition from the stress-reducing compartment 11 to the anesthetization compartment 12 should not re-agitate the animals. To this end, the anesthetization apparatus may be configured to expose the slaughter animals to a relaxation gas inside the transitional compartment 14, e.g. the same relaxation gas used in the stress-reducing compartment 11 or a similar or even a different relaxation gas, preferably a gas that does not cause anesthetization of the animals. The transitional compartment 14 may thus comprise a dispensing system for dispensing relaxation gas, or at least a component of the relaxation gas. The dispensing system may include a circulation system configured to maintain a substantially uniform atmosphere across the transitional compartment 14, in particular a substantially uniform concentration of the relaxation gas. The circulation system of the transitional compartment may be separate from a circulation system of the stress-reducing compartment so as to avoid undesired mixing of gases.

Yet further, the transitional compartment 14 may be configured to induce the same, similar or different additional stress-reducing measures as employed in the stress-reducing compartment 11. In particular the transitional compartment 14 may comprise a dispensing mechanism for dispensing a stress-reducing smell additive. The transitional compartment 14 may include one or more additional means for providing a stress-reducing environment and/or for calming the animals. In particular, the transitional compartment may include an illumination system for providing an illumination at an intensity and/or color suitable for calming the animals. Alternatively or additionally, the transitional compartment may include an audio system for playing music and/or other sounds of a type and at a volume suitable for calming the animals.

When the atmosphere and the stress-reducing measures in the transitional compartment 14 are similar or even the same as the corresponding atmosphere and stress-reducing measures in the stress-reducing compartment 11, the risk of agitating the animals during the transfer from the stress-reducing compartment, via the transitional compartment and into the anesthetization compartment is reduced.

The transitional compartment 14 is separated from the stress-reducing compartment 11 by a door, a gate, a curtain or other compartment divider 141 that can selectively be opened when a box is to be transferred from the stress-reducing compartment to the transitional compartment. The compartment divider 141 may e.g. be high-speed roller shutter. Preferably, the compartment divider 141 is configured to close the opening or other passageway between the stress-reducing compartment and the transitional compartment tight enough to prevent or at least minimize gas exchange between the transitional compartment and the stress-reducing compartment. This is advantageous even when the atmosphere in the transitional compartment is controlled to be similar to the atmosphere in the stress-reducing compartment, because the risk of anesthetizing gas leaking from the anesthetization compartment into the stress-reducing compartment is reduced. Generally, preventing or at least reducing undesired mixing of the various gases in the apparatus reduces the risk of undesired animal reactions and increases the efficiency of the gas utilization.

In particular, the embodiment of FIG. 4 is similar to the embodiment of FIG. 1, in that the various compartments of the apparatus are arranged on substantially the same level. Accordingly, the transitional compartment 14 is separated from the anesthetization compartment 12 by a door, a gate, a curtain or other compartment divider 121 that can selectively be opened when a box is to be transferred from the transitional compartment to the anesthetization compartment. The compartment divider 121 may e.g. be high-speed roller shutter. Preferably, the compartment divider is configured to close the opening or other passageway between the transitional compartment and the anesthetization compartment tight enough to prevent or at least minimize gas exchange between the transitional compartment and the stress-reducing compartment. The anesthetization apparatus 1 is preferably controlled such that the compartment divider 141 and the compartment divider 121 are not open concurrently, i.e. only opened one at a time.

The embodiment of FIG. 5 is similar to the embodiment of FIG. 2 in that the anesthetization compartment 12 is arranged at a lower level than the stress-reducing compartment 11. In this embodiment, the transitional compartment 14 is arranged at the same level as, and adjacent to, the stress-reducing compartment, in particular directly above the anesthetization compartment 12. Accordingly, the boxes are horizontally transferred from the stress-reducing compartment 11 to the transitional compartment 14 through compartment divider 141, which is temporarily opened to allow passage of the box. The compartment divider 141 is then closed again and the box is lowered into the anesthetization compartment 12 by a suitable elevation mechanism, where it remains until the animals are anesthetized. As the anesthetizing gas is typically heavier than the relaxation gas in the transitional compartment 14, there may not be any need for any compartment divider between the transitional compartment 14 and the anesthetization compartment 12, though some embodiments may indeed include such a compartment divider.

In the embodiment of FIG. 5, upon completion of the anesthetization, the box is again elevated into the transitional compartment 14. The transitional compartment 14 comprises an exit opening, preferably covered by a door, gate, curtain, or other compartment divider 142. Accordingly, the exit opening may be opened and the box may then be moved out of the transitional compartment 14 by the removal mechanism 13, e.g. a suitable conveyor. In some embodiments, the anesthetization compartment may be formed as a tunnel with separate entrance and exit, e.g. as described in connection with FIG. 3.

Generally, it will be appreciated that the stress-reducing compartment of any of the embodiments described above may be shaped and sized so as to accommodate a single box at a time or more than one box at a time, e.g. as a sequence or single file of boxes traversing the stress-reducing compartment.

Similarly, the anesthetization compartment of any of the above embodiments may be shaped and sized so as to accommodate a single box at a time or more than one box at a time, for example as a sequence or single file of boxes traversing the stress-reducing compartment.

Yet further, in the embodiments that include a transitional compartment, the transitional compartment may be shaped and sized so as to accommodate a single box at a time or more than one box at a time.

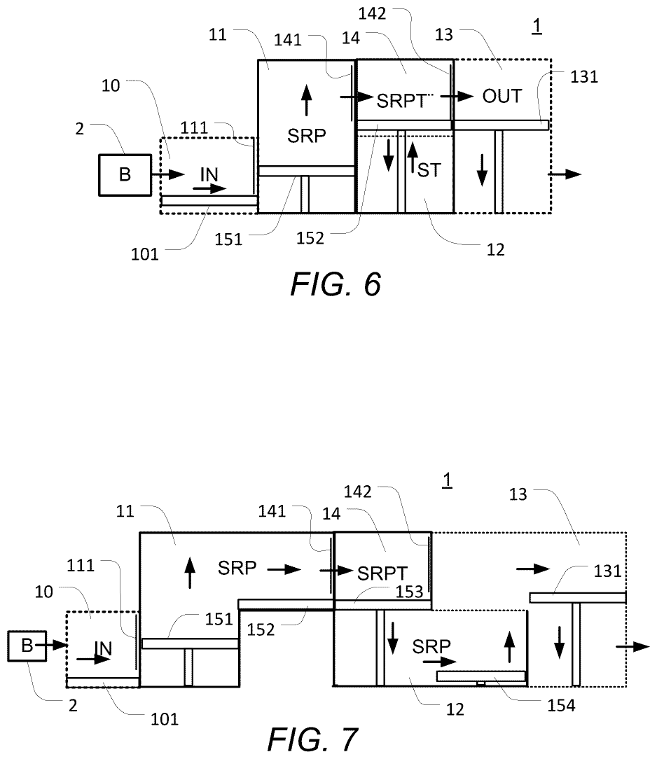

In the embodiment of FIGS. 6 and 7, the boxes are received at the receiving section 10 at a base level, e.g. at a floor level of a slaughter facility. Similarly, the boxes are removed from the anesthetization apparatus 1 by the removal mechanism 13 at the base level. All compartments of the apparatus are arranged at or above the base level, in particular at the base level and at an elevated level above the base level. It will be appreciated that, in alternative embodiments, the anesthetization apparatus may extend across more than two levels of height. It will also be appreciated that, in some embodiments, the receiving section and/or the removal mechanism may be configured to receive/discharge the animals at the elevated level instead of at the base level.

In the embodiment of FIG. 6, the boxes 2 are received at the receiving section 10 and positioned on a conveyor 101 or other suitable receiving mechanism. The conveyor 101 transports the received box through an inlet opening into the stress-reducing compartment 11. The inlet opening is covered by a door, gate curtain or other compartment divider 111 which is configured to be temporarily opened so as to allow passage of the box into the stress-reducing compartment 11. In the stress-reducing compartment 11, the box is placed on a lift 151, e.g. a scissor lift or other suitable type of elevating mechanism, and elevated to an elevated level. At the elevated level the box is transported horizontally into the transitional compartment 14, which is also located at the elevated level. To this end, there is an opening in the wall separating the stress-reducing compartment 11 and the transitional compartment 14 that is covered by a compartment divider 141 which can temporarily be opened so as to allow passage of the box, as described in connection with the previous embodiments. From the transitional compartment 14, the box is lowered by another lift 152 or other suitable elevating mechanism into the anesthetization compartment 12, which is located at the base level below the transitional compartment 14.

Upon completion of the anesthetization, the box is again elevated into the transitional compartment 14. The transitional compartment 14 comprises an exit opening, preferably covered by a door, gate, curtain, or other type of compartment divider 142. Accordingly, the exit opening may be opened and the box may then be moved out of the transitional compartment 14 onto another lift 131 of the removal mechanism, which again lowers the box to the floor level where it can be removed from the apparatus. It will be appreciated that, in other embodiments, the boxes may be received and/or removed from the apparatus at the elevated level rather than at the base level.

The embodiment of FIG. 7 is similar to the embodiment of FIG. 6 but differs from the embodiment of FIG. 6 in that the stress-reducing compartment 11 includes an elongated section at the elevated level where the boxes are moved horizontally along a conveyor 152. Hence, more than one box may be accommodated inside the stress-reducing compartment at the same time. Similarly, the anesthetization compartment 12 is also elongated having an inlet end and an exit end, as described in connection with the embodiment of FIG. 3. Accordingly, the anesthetization compartment may be shaped and sized so as to accommodate more than one box at a time, for example as a sequence or single file of boxes traversing the stress-reducing compartment. To this end, the boxes are lowered into the anesthetization compartment 12 from the transitional compartment by a lift 153 or other suitable elevation mechanism, then conveyed horizontally through the anesthetization compartment 12 towards the exit end of the compartment where the box is elevated by another lift 154 or other suitable elevation mechanism out of the anesthetization compartment 12 to the elevated level. The removal mechanism 13 may thus be configured to horizontally extract the box from the apparatus at the elevated level and, optionally, lower the box again by a lift 131 or other elevating mechanism to the floor level if required.

As in the embodiment of FIG. 3, even though the box does not return to the transitional compartment 14 after anesthetization, the transitional compartment 14 may optionally have an exit opening, covered by a suitable cover 142 anyway, so as to allow a box to be removed from the transitional compartment without entering the anesthetization compartment.

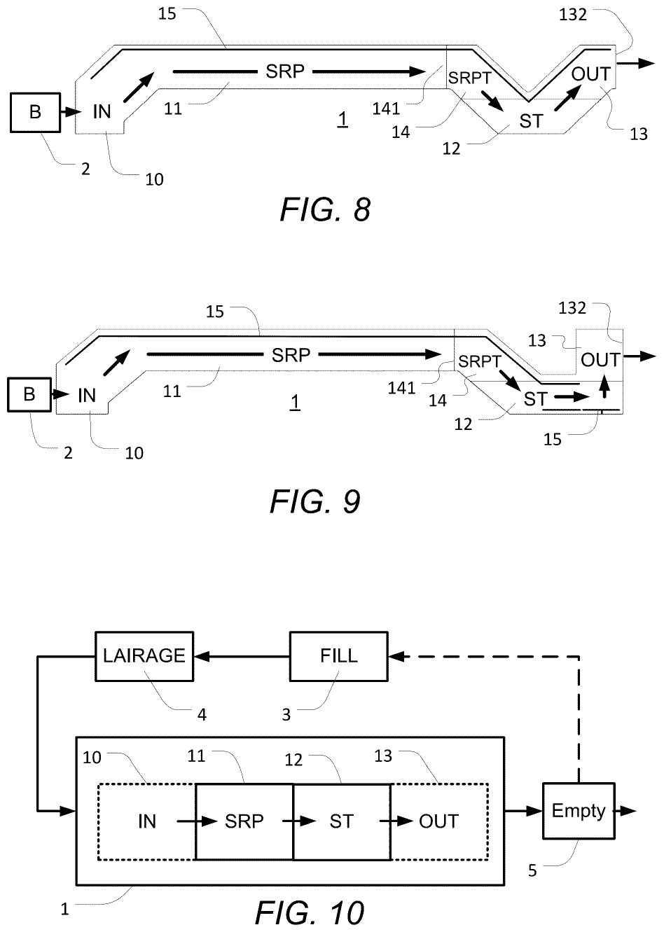

Generally, in the above and other embodiments where the compartments are arranged at different levels, the apparatus may include one or more elevating mechanisms as described herein or otherwise. In some embodiments, the elevating mechanism may be operable to move the boxes only vertically upwards or downwards, e.g. as illustrated in connection with FIGS. 2, 3 and 5-7. In alternative embodiments, one or more elevating mechanism may elevate or lower the boxes along an inclined trajectory, e.g. along a ramp or an inclined rail. Embodiments including such elevating mechanism will be described below with reference to FIGS. 8 and 9 below. Nevertheless, it will be appreciated that some or all of the embodiments described above may be implemented with an elevating mechanism that elevates or lowers the boxes along an inclined path.

The embodiments of FIGS. 8 and 9 are similar to the embodiment of FIG. 7 in that the boxes are received at the receiving section 10 at a base level, e.g. at a floor level of a slaughter facility, and that all compartments of the apparatus are arranged at or above the base level. In the embodiments of FIGS. 8 and 9, elevation and lowering of the boxes between the levels occurs at least in part along respective inclines.

In the embodiment of FIGS. 8 and 9, the boxes 2 are received at the receiving section 10 by transport mechanism 15. In the example of FIGS. 8 and 9, the transport mechanism includes an overhead rail from which the boxes are suspended. However, in other embodiments, the transport mechanism may have the form of a conveyor, other forms or rails or the like. The transport mechanism 15 transports the received box upwards along an incline into the stress-reducing compartment 11, which is located at an elevated level relative to the base level. The stress-reducing compartment may, at its inlet end, be separated from the receiving section by a door, gate curtain or other compartment divider (not explicitly shown in FIG. 8), which is configured to be temporarily opened so as to allow passage of the box into the receiving section. It will be appreciated that the inlet end of the stress-reducing compartment may be located at the base level or at the elevated level, i.e. elevation of the boxes from the base level to the elevated level may occur before and/or after entering the stress-reducing compartment. At the elevated level, the box is transported horizontally through the elongated stress-reducing compartment 11 and into a transitional compartment 14, which has an inlet end that is also located at the elevated level. The stress-reducing compartment 11 may be separated from the transitional compartment 14 by a wall with an opening that is covered by a compartment divider 141, which can temporarily be opened so as to allow passage of the box, as described in connection with the previous embodiments. From the transitional compartment 14, the box is lowered along another incline into the anesthetization compartment 12, which is located at the base level. It will be appreciated that, in other embodiments, the stress-reducing compartment 11 and the transitional compartment 14 may be combined into a single compartment and/or provided with the same or at least a similar stress-reducing atmosphere, including a relaxation gas, e.g. as described above.

Upon completion of the anesthetization, the box is elevated into an exit section 13. The exit section 13 comprises an exit opening, preferably covered by a door, gate, curtain, or other type of compartment divider 132. Accordingly, the exit opening may be opened and the box may then be moved out of the exit section 13, e.g. onto another lift or other removal mechanism, which may again lower the box to the floor level where it can be removed from the apparatus. It will be appreciated that, in other embodiments, the slaughter animals may be further processed at the elevated rather than at the base level, or they may be released from the boxes at the elevated level, or the boxes may otherwise be transported away from the apparatus at the elevated level.

The embodiments of FIGS. 8 and 9 differ from each other in that, in the embodiment of FIG. 8, the boxes are elevated from the anesthetization compartment 12 to the elevated exit section 13 along another incline, while, in the embodiment of FIG. 9, the boxes are elevated along a vertical path, e.g. by a scissor lift. Both embodiments allow the boxes to be transported all the way from the receiving section 10 into the anesthetization compartment 12 without abrupt changes in direction and/or unnecessarily many starts and stop, e.g. along a continuous track. In the embodiment of FIG. 8, the entire transport through the apparatus may be performed as a continuous movement, e.g. along a continuous track. The embodiment of FIG. 9 allows the longitudinal footprint of the apparatus to be kept smaller, while still allowing smooth transport of the slaughter animals as long as they are not yet anesthetized.

Generally, in the various embodiments described above, the boxes may traverse the anesthetization apparatus one by one, e.g. as a single file of boxes. In other embodiments, the apparatus may be configured such that two or more boxes may traverse the apparatus simultaneously, e.g. side by side, e.g. as two or more files or queues of boxes traversing the apparatus parallel or otherwise next to each other. Accordingly, the passageways between the compartments may be shaped and sized to allow passage of single box at a time or so as to allow two or more boxes to pass at the same time. Similarly, the receiving section may be configured to receive a single box at a time or multiple boxes concurrently. The transport mechanism, in particular the elevation mechanisms and/or the conveyor systems described in connection with the various embodiments, may be configured to transport a single box at a time, a single file of boxes, or even multiple boxes in parallel, e.g. side by side. Accordingly, the removal mechanism may be configured to remove a single box from the anesthetization compartment at a time or multiple boxes concurrently.

FIG. 10 schematically illustrates an embodiment of a slaughter facility. The slaughter facility includes an anesthetization apparatus as described herein, e.g. an apparatus as described in any of the embodiments of FIGS. 1-9. The slaughter facility further comprises a loading station 3 where the boxes are filled with slaughter animals, e.g. by encouraging the slaughter animals to walk into the boxes. The filled boxes are then transported to a lairage section where the animals are allowed to rest while in the boxes and then further to the anesthetization apparatus 1. Upon completion of the anesthetization process and removal of the boxes from the anesthetization apparatus, the boxes are emptied at removal station 5. The anesthetized animals are then processed further, in particular slaughtered. The empty boxes may then be returned to the loading station, optionally after cleaning, where they again can be filled with another group of slaughter animals.

Generally, various aspects disclosed herein may be summarized as follows:

Embodiment 1: An anesthetization apparatus for anesthetization of slaughter animals prior to slaughter, wherein the anesthetization apparatus comprises:
a receiving section configured to receive one or more pre-filled boxes, each pre-filled box containing one or more slaughter animals;
an anesthetization compartment;
a transport mechanism for transporting the received one or more boxes between the receiving section and the anesthetization compartment; and
a removal mechanism for removing the one or more boxes from the anesthetization compartment,
   wherein the anesthetization apparatus further comprises a stress-reducing compartment configured for receiving the one or more boxes from the receiving section and for accommodating the one or more boxes for a period of time for calming the slaughter animals in the received box before anesthetizing; and wherein the transport mechanism is configured to transport the one or more boxes between the receiving section and the stress-reducing compartment and from the stress-reducing compartment to the anesthetization compartment.

Embodiment 2: The anesthetization apparatus according to embodiment 1, wherein the receiving section is arranged at a first level and wherein the transport mechanism comprises:
a first elevating mechanism for elevating the one or more boxes from the first level to a second level higher than the first level; and
a second elevating mechanism for lowering a box from second level into the anesthetization compartment, wherein the anesthetization compartment is optionally arranged at the first level.

Embodiment 3: The anesthetization apparatus according to any of the preceding embodiments; comprising a transitional compartment shaped and sized to accommodate the one or more boxes, and wherein the transport mechanism is configured to transport the one or more boxes from the stress-reducing compartment to the transitional compartment and from the transitional compartment to the anesthetization compartment.

Embodiment 4: The anesthetization apparatus according to embodiment 3, wherein the transitional compartment is arranged above the anesthetization compartment.

Embodiment 5: The anesthetization apparatus according to embodiment 3 or 4, wherein the transitional compartment is arranged on the same level as the stress-reducing compartment.

Embodiment 6: The anesthetization apparatus according to embodiment 5, wherein transport mechanism comprises a horizontal transport mechanism configured to move the one or more boxes horizontally between the stress-reducing compartment and the transitional compartment.

Embodiment 7: The anesthetization apparatus according to any one of embodiments 3 through 6, wherein the removal mechanism is configured to transport the one or more boxes from the anesthetization compartment via the transitional compartment to an exit port of the apparatus.

Embodiment 8: The anesthetization apparatus according to any one of embodiments 3 through 7, comprising a passageway between the stress-reducing compartment and the transitional compartment, the passageway being sized and shaped to allow passage of the one or more boxes from the stress-reducing compartment to the transitional compartment, and wherein the anesthetization apparatus further comprises a compartment divider configured to selectively block the passageway between the stress-reducing compartment and the transitional compartment.

Embodiment 9: An anesthetization apparatus for anesthetizing slaughter animals prior to slaughter, wherein the anesthetization apparatus comprises:
a receiving section configured to receive one or more slaughter animals in one or more boxes;
an anesthetization compartment;
a transport mechanism for transporting the one or more boxes between the receiving section and the anesthetization compartment; and
a removal mechanism for removing the one or more boxes from the anesthetization compartment,
a stress-reducing compartment configured for receiving the one or more boxes from the receiving section, accommodating the one or more boxes for a period of time for calming the slaughter animals in the one or more boxes before anesthetizing, and a
a transitional compartment shaped and sized to accommodate the one or more boxes,
   wherein the transport mechanism is configured to transport the one or more boxes between the receiving section and the stress-reducing compartment, from the stress-reducing compartment to the transitional compartment and from the transitional compartment to the anesthetization compartment; wherein the transitional compartment is separated from the stress-reducing compartment by a compartment divider configured to selectively block a passageway between the stress-reducing compartment and the transitional compartment.

Embodiment 10: The anesthetization apparatus according to any one of the preceding embodiments, comprising means for dispensing an anesthetizing gas into the anesthetization compartment.

Embodiment 11: The anesthetization apparatus according to any one of the preceding embodiments, wherein the anesthetization compartment has a bottom and one or more side walls and comprises an access door in said one or more side walls and/or a transparent window portion in said one or more side walls.

Embodiment 12: An anesthetization apparatus for anesthetizing slaughter animals prior to slaughter, wherein the anesthetization apparatus comprises:
a receiving section configured to receive one or more slaughter animals in one or more boxes;
an anesthetization compartment;
a transport mechanism for transporting the one or more boxes between the receiving section and the anesthetization compartment; and
a removal mechanism for removing the one or more boxes from the anesthetization compartment,
   wherein the anesthetization compartment has a bottom and one or more side walls and comprises an access door and/or a transparent window portion in said one or more side walls.

Embodiment 13: The anesthetization apparatus according to any one of the preceding embodiments, wherein the stress-reducing compartment comprises one or more of:
means for providing a stress-reducing gas atmosphere, in particular an oxygen-reduced atmosphere, in the stress-reducing compartment,
a sound insulated enclosure for accommodating the one or more boxes,
a sound system for playing stress-reducing audio content,
an illumination system for providing stress-reducing illumination.

Embodiment 14: The anesthetization apparatus according to any one of the preceding embodiments, wherein the stress-reducing compartment and/or the anesthetization compartment is shaped and sized to accommodate a plurality of boxes concurrently.

Embodiment 15: The anesthetization apparatus according to any one of the preceding embodiments, wherein the stress-reducing compartment is arranged above the receiving section.

Embodiment 16: The anesthetization apparatus according to any one of the preceding embodiments, comprising means for supplying the anesthetization compartment and/or the stress-reducing compartment with at least one smell additive.

Embodiment 17: A slaughter facility comprising an anesthetization apparatus according to any one of the preceding embodiments, optionally further comprising:
a lairage section for accommodating one or more boxes, each box containing one or more slaughter animals, and
a transport mechanism for transporting a box from the lairage section to the receiving section of the anesthetization apparatus.

Embodiment 18: A method for anesthetization of slaughter animals prior to slaughter, wherein the method comprises:
receiving a pre-filled box containing one or more slaughter animals,
transporting the received box to a stress-reducing compartment,
accommodating the box inside the stress-reducing compartment for a period of time,
transporting the box between the stress-reducing compartment to an anesthetization compartment, anesthetizing the animals, in particular by exposing the animals to an anesthetic gas, removing the box with the anesthetized animals from the anesthetization compartment.

While embodiments of the invention have been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1-18. (canceled).

19. An anesthetization apparatus for anesthetization of slaughter animals prior to slaughter, wherein the anesthetization apparatus comprises:
a receiving section configured to receive one or more pre-filled boxes, each pre-filled box containing one or more slaughter animals;
a anesthetization compartment;
a transport mechanism for transporting the received one or more boxes between the receiving section and the anesthetization compartment; and
a removal mechanism for removing the one or more boxes from the anesthetization compartment,
wherein the anesthetization apparatus further comprises a stress-reducing compartment configured for receiving the one or more boxes from the receiving section and for accommodating the one or more boxes for a period of time for calming the slaughter animals in the received box before anesthetizing; and
wherein the transport mechanism is configured to transport the one or more boxes between the receiving section and the stress-reducing compartment and from the stress-reducing compartment to the anesthetization compartment.

20. The anesthetization apparatus according to claim 19, wherein the receiving section is arranged at a first level and
wherein the transport mechanism comprises:
a first elevating mechanism for elevating the one or more boxes from the first level to a second level higher than the first level; and
a second elevating mechanism for lowering a box from second level into the anesthetization compartment, wherein the anesthetization compartment is optionally arranged at the first level.

21. The anesthetization apparatus according to claim 19, comprising a transitional compartment shaped and sized to accommodate the one or more boxes, and
wherein the transport mechanism is configured to transport the one or more boxes from the stress-reducing compartment to the transitional compartment and from the transitional compartment to the anesthetization compartment.

22. The anesthetization apparatus according to claim 21, wherein the transitional compartment is arranged at an elevated level partly or completely above the anesthetization compartment.

23. The anesthetization apparatus according to claim 21, wherein the transitional compartment is arranged on the same level as the stress-reducing compartment.

24. The anesthetization apparatus according to claim 23, wherein transport mechanism comprises a horizontal transport mechanism configured to move the one or more boxes horizontally between the stress-reducing compartment and the transitional compartment.

25. The anesthetization apparatus according to claim 21, wherein the removal mechanism is configured to transport the one or more boxes from the anesthetization compartment via the transitional compartment to an exit port of the apparatus.

26. The anesthetization apparatus according to claim 21, comprising a passageway between the stress-reducing compartment and the transitional compartment, the passageway being sized and shaped to allow passage of the one or more boxes from the stress-reducing compartment to the transitional compartment, and
wherein the anesthetization apparatus further comprises a compartment divider configured to selectively block the passageway between the stress-reducing compartment and the transitional compartment.

27. An anesthetization apparatus for anesthetizing slaughter animals prior to slaughter, wherein the anesthetization apparatus comprises:
a receiving section configured to receive one or more slaughter animals in one or more boxes;
an anesthetization compartment;
a transport mechanism for transporting the one or more boxes between the receiving section and the anesthetization compartment; and
a removal mechanism for removing the one or more boxes from the anesthetization compartment,
a stress-reducing compartment configured for receiving the one or more boxes from the receiving section, accommodating the one or more boxes for a period of time for calming the slaughter animals in the one or more boxes before anesthetizing, and a
a transitional compartment shaped and sized to accommodate the one or more boxes,
wherein the transport mechanism is configured to transport the one or more boxes between the receiving section and the stress-reducing compartment, from the stress-reducing compartment to the transitional compartment and from the transitional compartment to the anesthetization compartment; wherein the transitional compartment is separated from the stress-reducing compartment by a compartment divider configured to selectively block a passageway between the stress-reducing compartment and the transitional compartment.

28. The anesthetization apparatus according to claim 19, comprising means for dispensing an anesthetizing gas into the anesthetization compartment.

29. The anesthetization apparatus according to claim 19, wherein the anesthetization compartment has a bottom and one or more side walls and defines one or more upwardly open entrance and/or exit openings configured to allow the boxes to enter and/or exit the anesthetization compartment, and
wherein the anesthetization compartment comprises an access door in said one or more side walls and/or a transparent window portion in said one or more side walls.

30. An anesthetization apparatus for anesthetizing slaughter animals prior to slaughter, wherein the anesthetization apparatus comprises:
a receiving section configured to receive one or more slaughter animals in one or more boxes;
a anesthetization compartment;
a transport mechanism for transporting the one or more boxes between the receiving section and the anesthetization compartment; and
a removal mechanism for removing the one or more boxes from the anesthetization compartment,
wherein the anesthetization compartment has a bottom and one or more side walls and defines one or more upwardly open entrance and/or exit openings configured to allow the boxes to enter and/or exit the anesthetization compartment, and
wherein the anesthetization compartment further comprises an access door and/or a transparent window portion in said one or more side walls.

31. The anesthetization apparatus according to claim 19, wherein the stress-reducing compartment comprises one or more of:
means for providing a stress-reducing gas atmosphere, in the stress-reducing compartment,
a sound insulated enclosure for accommodating the one or more boxes,
a sound system for playing stress-reducing audio content,
an illumination system for providing stress-reducing illumination.

32. The anesthetization apparatus according to claim 19, wherein the stress-reducing compartment and/or the anesthetization compartment is shaped and sized to accommodate a plurality of boxes concurrently.

33. The anesthetization apparatus according to claim 19, wherein the stress-reducing compartment is arranged above the receiving section.

34. The anesthetization apparatus according to claim 19, comprising means for supplying the anesthetization compartment and/or the stress-reducing compartment with at least one smell additive.

35. A slaughter facility comprising an anesthetization apparatus according to claim 19, optionally further comprising:
a lairage section for accommodating one or more boxes, each box containing one or more slaughter animals, and
a transport mechanism for transporting a box from the lairage section to the receiving section of the anesthetization apparatus.

36. A method for anesthetization of slaughter animals prior to slaughter,
wherein the method comprises:
receiving a pre-filled box containing one or more slaughter animals,
transporting the received box to a stress-reducing compartment,
accommodating the box inside the stress-reducing compartment for a period of time,
transporting the box between the stress-reducing compartment to a anesthetization compartment, anesthetizing the animals, by exposing the animals to an anesthetic gas, removing the box with the anesthetized animals from the anesthetization compartment.
